(19) United States
(12) Patent Application Publication
(10) Pub. No.: US 2024/0336477 A1
(43) Pub. Date: Oct. 10, 2024

(54) High Capacity Hydrogen Storage through Selective Nano-Confined and Localized Hydrogen Hydrates

(71) Applicant: University of Houston System, Houston, TX (US)

(72) Inventor: Hadi Ghasemi, Spring, TX (US)

(73) Assignee: University of Houston System, Houston, TX (US)

(21) Appl. No.: 18/292,013

(22) PCT Filed: Aug. 8, 2022
(86) PCT No.: PCT/US2022/039723

§ 371 Date: Jan. 25, 2024

Related U.S. Application Data
(60) Provisional application No. 63/230,081, filed on Aug. 6, 2021.

(51) Int. Cl. C01B 3/00; H01M 10/34

(52) U.S. Cl. CPC C01B 3/0084; C01B 3/0015; H01M 10/345

(57) ABSTRACT

A hydrogen storage device comprising (i) hydrogen gas and (ii) a host framework material. A hydrogen discharge device comprising (i) hydrogen gas and (ii) a host framework material. A method of storing hydrogen comprising introducing hydrogen gas to a host framework material comprising a zeolite, carbon, silica, nickel foam, carbon nanosponge (CNS), a graphene aerogel or a combination thereof under conditions suitable for the formation of hydrogen gas hydrates. A battery comprising a host framework material comprising hydrogen gas hydrates wherein the host framework material comprises a zeolite, carbon, silica, nickel foam, carbon nanosponge (CNS), a graphene aerogel or a combination thereof.

### CROSS REFERENCE TO RELATED APPLICATIONS

This application is a 35 U.S.C. § 371 national stage application of PCT/US2022/039723 filed Aug. 8, 2022, and entitled, “High Capacity Hydrogen Storage Through Selective Nano-Confined and Localized Hydrogen Hydrates,” which claims benefit of U.S. provisional patent application Ser. No. 63/230,081 filed Aug. 6, 2021, and entitled “High Capacity Hydrogen Storage Through Selective Nano-Confined and Localized Hydrogen Hydrates,” each of which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates generally to the storage of hydrogen, and more specifically, to the storage of hydrogen through selective nano-confined and localized hydrogen hydrates.

### BACKGROUND

In the future landscape of sustainable energies and in combating global climate challenges, hydrogen plays an important role in both stationary and portable energy systems and could comprise 18% of the total energy demand. Hydrogen is recognized as the “future fuel” and the most promising alternative to fossil fuels due to its remarkable properties including exceptionally high energy content per unit mass (142 MJ/kg), low mass density, and massive environmental and economical upsides.

### SUMMARY OF THE DISCLOSURE

Disclosed herein is a hydrogen storage device comprising (i) hydrogen gas and (ii) a host framework material.

Also disclosed herein is a hydrogen discharge device comprising (i) hydrogen gas and (ii) a host framework material.

Also disclosed herein is a method of storing hydrogen comprising introducing hydrogen gas to a host framework material comprising a zeolite, carbon, silica, nickel foam, carbon nanosponge (CNS), a graphene aerogel or a combination thereof under conditions suitable for the formation of hydrogen gas hydrates.

Also disclosed herein is a battery comprising a host framework material comprising hydrogen gas hydrates wherein the host framework material comprises a zeolite, carbon, silica, nickel foam, carbon nanosponge (CNS), a graphene aerogel or a combination thereof.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1A depicts a schematic of a material platform for high-capacity hydrogen storage.

FIG. 1B compares the role of pore dimension on hydrogen solubility compared to the bulk material for the samples of Example 1. The ordering of water molecules in 3 nm pore leads to 2-3 folds enhancement of hydrogen solubility.

FIG. 1C depicts the concavity of pores of a host framework material of the type disclosed herein.

FIG. 2 is a flow diagram of a method of producing a hydrogen storage device, according to aspects of this disclosure; and

FIG. 3 is a flow diagram of a method of storing hydrogen, according to aspects of this disclosure.

FIG. 4A depicts a graph of the host framework material storage capacity compared with other state-of-the-art materials in the operating pressure range of 1-12 bar.

FIG. 4B is a bar graph depicting the charging time of various material structures

FIG. 4C is a bar graph depicting the discharging time of various hydrogen storage materials along with their corresponding discharging temperature.

FIG. 5 is a schematic of the experimental setup of a hydrogen storage system of the type disclosed herein.

### DETAILED DESCRIPTION

Certain aspects of the present disclosure may include some, all, or none of the disclosed advantages and/or one or more other advantages readily apparent to those skilled in the art from the drawings, descriptions, and claims included herein. Moreover, while specific advantages have been enumerated, the various aspects of the present disclosure may include all, some, or none of the enumerated advantages and/or other advantages not specifically enumerated.

The phrases “in an aspect,” “in aspects,” “in various aspects,” “in some aspects,” or “in other aspects” may each refer to one or more of the same or different aspects in accordance with the present disclosure. The phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the description provided herein is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the subject matter described herein. A “consisting essentially of” claim occupies a middle ground between closed claims that are written in a “consisting of” format and fully open claims that are drafted in a “comprising” format. Absent an indication to the contrary, when describing a compound or composition “consisting essentially of” is not to be construed as “comprising,” but is intended to describe the recited component that includes materials which do not significantly alter the composition or method to which the term is applied. When a claim includes different features and/or feature classes (for example, a method step and/or product features, among other possibilities), the transitional terms “comprising,” “consisting essentially of,” and “consisting of” apply only to the feature class which is utilized and it is possible to have different transitional terms or phrases utilized with different features within a claim. For example, a method can comprise several recited steps (and other non-recited steps) but utilize a material consisting of specific steps; or alternatively, consist of specific steps and/or utilize a material comprising recited components and other non-recited components.

Within this specification, use of “comprising” or an equivalent expression contemplates the use of the phrase “consisting essentially of,” “consists essentially of,” or equivalent expressions as alternative aspects to the open-ended expression. Additionally, use of “comprising” or an equivalent expression or use of “consisting essentially of” in the specification contemplates the use of the phrase “consisting of,” “consists of,” or equivalent expressions as an alternative to the open-ended expression or middle ground expression, respectively. For example, “comprising” should be understood to include “consisting essentially of,” and “consisting of” as alternative aspects for the aspect, features, and/or elements presented in the specification unless specifically indicated otherwise.

While compositions and methods are described in terms of “comprising” various components or steps, the compositions and methods can also “consist essentially of” or “consist of” the various components or steps.

The terms “a,” “an,” and “the” are intended, unless specifically indicated otherwise, to include plural alternatives, e.g., at least one. For purposes of promoting an understanding of the principles of the present disclosure, reference will be made to exemplary aspects illustrated in the drawings, and specific language will be used to describe the same. It will nevertheless be understood that no limitation of the scope of the present disclosure is thereby intended. Any alterations and further modifications of the features illustrated herein, and any additional applications of the principles of the present disclosure as illustrated herein, which would occur to one skilled in the relevant art and having possession of this disclosure, are to be considered within the scope of the present disclosure.

High-capacity, safe, and cost-effective hydrogen storage may be one of the keys to hydrogen economic growth, but remains a daunting challenge. A range of advanced material systems including metal hydrides, metal-organic frameworks and 2D material have been explored to achieve high storage capacity, but high operating pressures, low charging/discharging rate and energy intensive discharging processes have hindered their growth and deployment. Accordingly, a need exists for improved hydrogen storage devices. Desirably, the hydrogen storage device provides for high storage capacity, with fast charging/discharging and ambient temperature discharging process.

Disclosed herein is a high capacity hydrogen storage material and device comprising the high capacity hydrogen storage material as a component. In one or more aspects, the high capacity hydrogen storage material has a hydrogen storage capacity that surpasses the capacity of conventional materials by several fold. Additionally, the high capacity hydrogen storage materials of the present disclosure are further characterized by (i) an ability to rapidly charge/discharge and (ii) an ambient temperature discharging process.

Here in a high capacity hydrogen storage material is referred to a H₂-HICAP and a device comprising a H₂-HICAP is termed a hydrogen storage device. In one or more aspects, the H₂-HICAP is used in the formation of a hydrogen hydrate based on physically trapping molecular hydrogen in water lattices.

In one or more aspects, the H₂-HICAP comprises (i) H₂ gas guest molecules and (ii) a host framework material. Conventional hydrate formation typically occurs through the mixing of hydrogen gas and water. In an aspect of the present disclosure, hydrate formation occurs through contacting hydrogen as a guest molecule with a host framework material under conditions suitable for the production and storage of a hydrogen hydrate.

A host framework material suitable for use in the present disclosure may be characterized by the following characteristics: (1) it can provide a platform for interfacial hydrate formation rather than bulk hydrate formation; (2) through rational selection of pore dimensions, the water molecules can be layered in the pore of the host material leading to 2-3 times enhanced hydrogen absorption and fast nucleation; (3) a curvature of pores in the host framework can enhance the nucleation rate of hydrate particles; (4) a functionalized pore surface can lower an energy barrier for hydrate nucleation; (5) a confinement effect that can allow for high hydrogen storage capacity and a combination of any of (1)-(5). In one or more aspects, a host framework material suitable for use in the present disclosure has characteristics (1)-(5). It is contemplated that a H₂-HICAP comprising hydrogen hydrates may function as a hydrogen storage device in the absence of any other components. In an alternative aspect, the H₂-HICAP is a component of a device having additional features that is utilized as a hydrogen storage device.

In one or more aspects, the H₂-HICAP comprises a host framework material which is nanoporous material containing water and/or floating on water and is operable for storage of hydrogen as hydrogen hydrates. Nanoporous materials herein refer to materials consisting of a regular organic or inorganic bulk phase in which a porous structure is present. Nanoporous materials exhibit pore diameters that are most appropriately quantified using units of nanometers. In an aspect, the nanoporous materials suitable for use in the present disclosure comprise open pores which are pores that connect to the surface of the material.

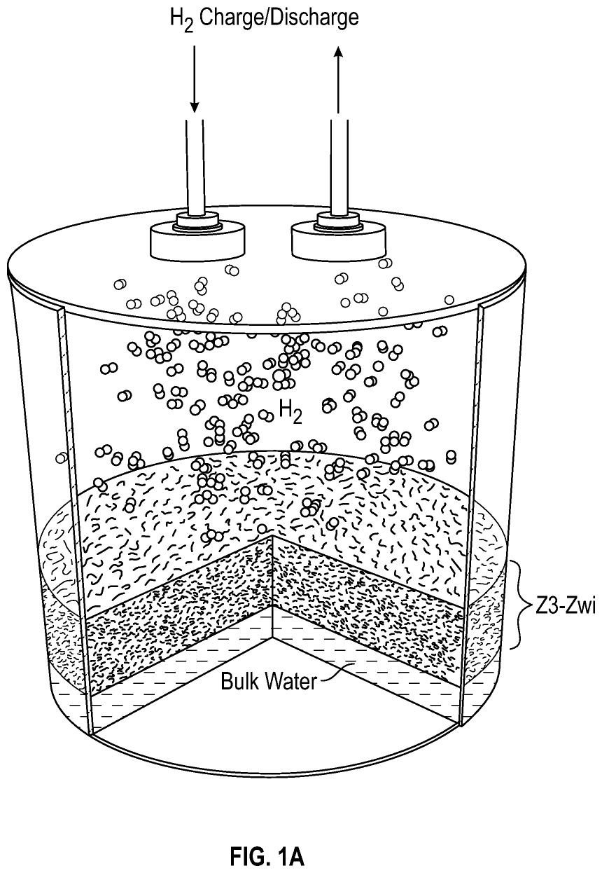

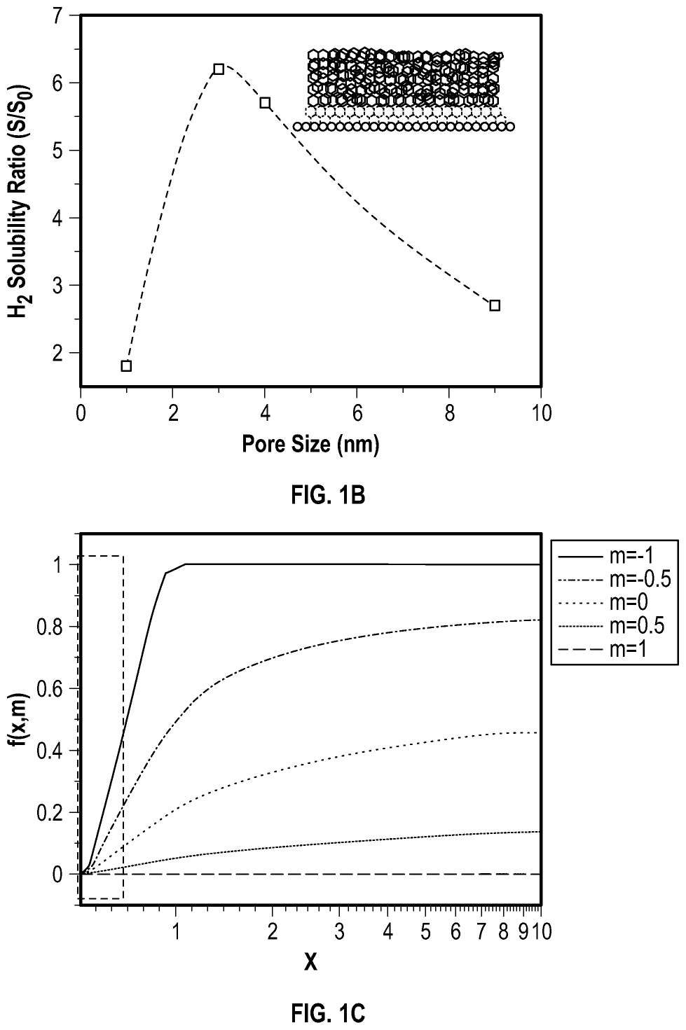

FIG. 1 is a schematic depiction of a hydrogen storage system, according to aspects of this disclosure. Hydrogen storage system I comprises a hydrogen storage device. Hydrogen storage device 10 comprises a H₂-HICAP. H₂-HICAP floats on water and/or contains water, during operation of hydrogen storage system I.

In aspects, the host framework material is a nanoporous zeolite. Zeolites are crystalline, hydrated aluminosilicates of the alkali and alkaline earth metals. More particularly, zeolites are framework silicates consisting of interlocking tetrahedrons of SiO₄ and AlO₄. In order to constitute a zeolite the ratio of silicon and aluminum to oxygen must be 1/2. The alumino-silicates structure is negatively charged and attracts the positive cations that reside within. Unlike most other tectosilicates, zeolites have large vacant spaces or cages in their structures that allow space for large cations such as sodium, potassium, barium, and calcium and relatively large molecules and cationic molecules, such as water, ammonia, carbonate ions, and nitrate ions. In most zeolites, the spaces are interconnected and form long wide channels of varying sizes depending on the mineral. These channels allow ease of movement of the resident ions and molecules into and out of the structure. Zeolites are characterized by 1) a high degree of hydration, 2) low density and a large void volume when dehydrated, 3) stability of the crystal structure of many zeolites when dehydrated, 4) uniform molecular sized channels in the dehydrated crystals, 5) ability to absorb gases and vapors, 6) catalytic properties, and 7) cation exchange properties. Any zeolite compatible with the other components of the H₂-HICAP may be utilized as the host framework material. In an aspect, the host framework material comprises zeolite Z3-Zwi.

In aspects, the pores of the host framework material are substantially spherical, providing a concave shape for formation of the hydrogen hydrates. The pores of the host framework material can be less than or equal to about 5, 4, 3, 2, or 1 nm (e.g., about equal to 3 nm) in average diameter. In an aspect, the average pore diameter of the host framework material ranges from about 0.2 nm to about 10 nm, alternatively from about 0.2 nm to about 5 nm or alternatively from about 1 nm to about 3 nm.

In aspects, a surface of the host framework material (e.g., zeolite) is functionalized, alternatively the surface of the host framework material is functionalized to increase the hydrophilicity of the surface. For example, the surface of the host framework material may be functionalized with moieties that provide charges on the surface of the material such as zwitterions. Herein functionalization of the surface of the host framework material can include the interior surface (e.g., within the pores) and or exterior surface of the host framework material. In an aspect, the surface is functionalized with one or more chemical groups that facilitate the formation of a hydration layer on one or more surfaces of the host framework material. Functionalization of the host framework material may be carried out using any suitable methodology (e.g., sulfonic acid treatment).

In aspects, the hydrogen storage device 10 depicted in FIG. 1 comprises multiple layers of the host framework material (e.g., zeolite). Each layer of host framework material 6 in the hydrogen storage device 10 can have suitable shape, such as, for example, circular or disk shaped, as depicted in FIG. 1, or rectangular, square, triangular, or another shape. The host framework material 6 can comprise any material that provides the requisite features described, e.g., comprises nanopores. For example and without limitation, the host framework material 6 can comprise zeolite, carbon, silica, nickel foam, carbon nanosponge (CNS), graphene aerogel or a combination thereof. In aspects, the host framework material 6 comprises a zeolite. In one or more aspects, the host framework material 6 comprises a mesoporous carbon. As utilized herein, “mesoporous carbon” refers to a carbon material containing pores having diameters in a range of from about 2 to about 50 nm.

In specific aspects, the host framework material comprises a zeolite having one or more surfaces functionalized with zwitterions and substantially spherical pores having an average diameter of about 3 nm that provide a concave shape for formation of the hydrogen hydrates.

In aspects, the hydrogen storage device comprising or consisting essentially of a H₂-HICAP is characterized by a long-term stability. Herein stability of the hydrogen storage device refers to a device able to complete greater than about 1000 cycles with a less than about 10% deviation in performance. The hydrogen storage device comprising or consisting essentially of a H₂-HICAP of the present disclosure may have a stability of from about 100 cycles to about 100,000 cycles, alternatively greater than about 100 cycles, alternatively greater than about 10,000 cycles or alternatively greater than about 100,000 cycles. Herein a cycle refers to the period from which a hydrogen storage device comprising or consisting essentially of a H₂-HICAP is filled with hydrogen hydrates to the depletion of this device to contain less than about 10% hydrogen hydrates.

In aspects, the hydrogen storage capacity of a hydrogen storage device comprising or consisting essentially of a H₂-HICAP is greater than or equal to about 1.5 weight percent (wt. %) at pressures from about 2 to about 12 bar (about 0.2 to about 1.2 MPa), and/or is at least 2, 3, 4, and/or 5 times a hydrogen storage capacity of other state-of-the-art materials in a pressure range of from about 1 to about 12 bar (from about 0.1 to about 1.2 MPa. For example, the hydrogen storage device comprising or consisting essentially of a H₂-HICAP of the present disclosure may have a storage capacity of from about 0.1 wt. % to about 40 wt. %, alternatively from about 0.1 wt. % to about 5 wt. % or alternatively from about 2 wt. % to about 10 wt. % at a pressure of from about 1 bar to about 100 bar, alternatively from about 1 bar to about 12 bar or alternatively from about 5 bar to about 12 bar.

In aspects, the storage capacity of the hydrogen storage device comprising or consisting essentially of a H₂-HICAP has a hydrogen storage capacity of at least 2.5% weight percent (wt. %) (e.g., greater than or equal to about 2.5 wt %) hydrogen at 6 bar (0.6 MPa).

In aspects, the hydrogen storage device comprising or consisting essentially of a H₂-HICAP provides a hydrate formation rate that is greater than or equal to about 2.78 (H₂ wt. %/hr), and/or at least 20 times higher than a hydrate formation rate of bulk water hydration. Herein the hydrate formation rate refers to is determined by released heat of hydration.

In aspects, a charging time to a storage capacity (e.g., a “full” storage capacity) of the hydrogen storage device comprising or consisting essentially of a H₂-HICAP is less than a charging time to a storage capacity (e.g., a full hydrogen storage capacity) of other state-of-the-art materials in a pressure range of from about 1 to about 12 bar (from about 0.1 to about 1.2 MPa).

In aspects, a hydrogen discharging time (e.g., a discharging time until empty of stored hydrogen) of the hydrogen storage device comprising or consisting essentially of a H₂-HICAP is less (and/or a hydrogen discharging rate is greater) than a hydrogen discharging time (e.g., a discharging time until empty of stored hydrogen) (and/or hydrogen discharging rate) of other state-of-the-art materials in a pressure range of from about 1 to about 12 bar (from about 0.1 to about 1.2 MPa). In an aspect, the hydrogen storage device comprising or consisting essentially of a H₂-HICAP has a discharge time ranging from about 1 second (s) to about 10000 s, alternatively from about 10 s to about 600 s or alternatively from about 1 s to about 600 s at a pressure of from about 1 bar to about 12 bar, alternatively from about 5 bar to about 12 bar or alternatively from about 5 bar to about 12 bar.

A hydrogen storage system I (FIG. 1) can be produced by floating the hydrogen storage device 10 in water 40 in a sealed chamber or container 50 and/or soaking the hydrogen storage device 10 in water in (or providing a water-soaked hydrogen storage device 10 to) the sealed chamber or container 50, wherein the chamber or container 50 has an inlet 60 for charging the hydrogen storage device 10 with hydrogen 5 and an outlet 70 for discharging hydrogen gas from the hydrogen storage device 10. For example, when a wetted porous material 6 (e.g., a wetted zeolite) is employed as hydrogen storage device 10 for the hydrogen storage, no additional water 50 may be utilized underneath of the wetted material (e.g., underneath the wetted zeolite).

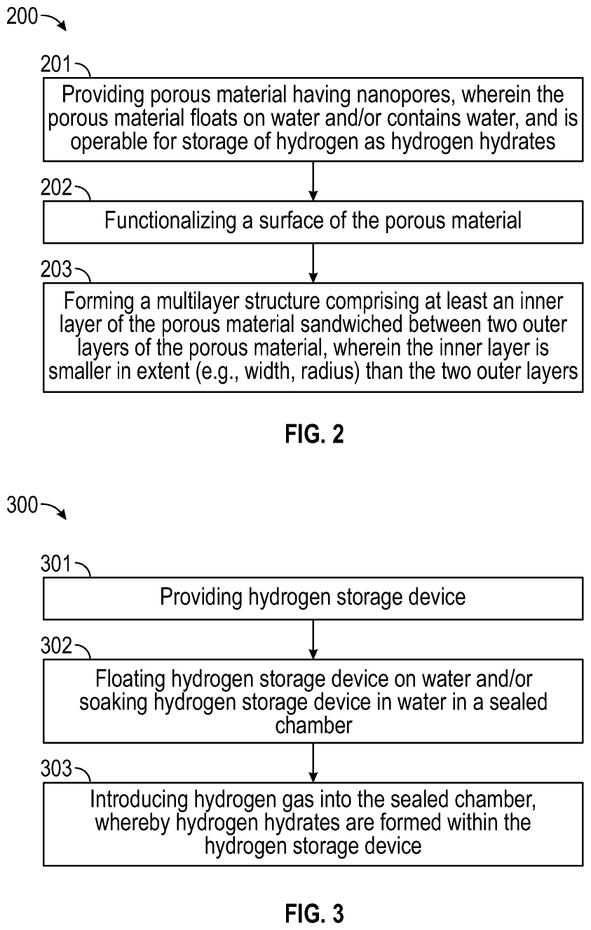

FIG. 2 is a process flow diagram of a method 200 for the production of a hydrogen storage device. The hydrogen storage device 10 produced via the method 200, designated H₂-HICAP-200, can have the properties noted herein.

The hydrogen storage H₂-HICAP-200 can have a hydrogen storage capacity of greater than or equal to about 2.5 wt % at pressures from about 2 to about 12 bar (about 0.2 to about 1.2 MPa), and/or can be at least 2 to 5 times a hydrogen storage capacity of other state-of-the-art materials in a pressure range of from about 1 to about 12 bar (from about 0.1 to about 1.2 MPa). In aspects, the H₂-HICAP-200 can have a hydrogen storage capacity (or simply “storage capacity”) of at least 3, 4, 4.5 weight percent (wt %). For example, in aspects such as when the H₂-HICAP-200 comprises Z3-Zwi, the hydrogen storage capacity can be greater than or equal to about 2.5 wt % hydrogen at 6 bar (0.6 MPa).

With reference to FIG. 2, the H₂-HICAP-200 has a hydrate formation rate that is greater than or equal to a 2.78 (H₂ wt %/hr) and/or is at least 20 times higher than a hydrate formation rate of bulk water hydration. In some aspects, such as when the H₂-HICAP-200 comprises Z3-Zwi, the hydrate formation rate of the hydrogen storage device at 6 bar (0.6 MPa) is at least 20 times the hydrate formation rate of bulk water hydration.

In aspects, a charging time to a (e.g., full) storage capacity of the H₂-HICAP-200 is less than a charging time to a (e.g., full) hydrogen storage capacity of other state-of-the-art materials in a pressure range of from about 1 to about 12 bar (from about 0.1 to about 1.2 MPa).

In aspects, a hydrogen discharging time (e.g., to empty) of the H₂-HICAP-200 is less (and/or a hydrogen discharging rate is greater) than a hydrogen discharging time (e.g., to empty) (and/or hydrogen discharging rate) of other state-of-the-art materials in a pressure range of from about 1 to about 12 bar (from about 0.1 to about 1.2 MPa).

Also provided herein is a method of storing hydrogen. Such a method will now be described with reference to FIG. 3, which is a flow diagram of a method 300 of storing hydrogen, according to aspects of this disclosure. As depicted in FIG. 3, method 300 comprises providing, at 301, a hydrogen storage device 10 as described herein; at 302, floating the hydrogen storage device 10 on water 40 in a sealed chamber 50 and/or soaking the hydrogen storage device 10 in water 40 prior to or subsequent introduction of the hydrogen storage device 10 to sealed chamber 50; and introducing, at 303, hydrogen gas 5 into the sealed chamber 50, whereby hydrogen hydrates are formed within the hydrogen storage device 10.

Introducing of the hydrogen gas 5 into the sealed chamber 50 can be effected at a pressure in a range of from about 1 to about 12 bar (from about 0.1 to about 1.2 MPa) or less than or equal to about 15, 14, 13, 12, 11, 10, 9, 8, 7, 6, 5, 4, 3, 2, or 1 bar (less than or equal to about 1.5, 1.4, 1.3, 1.2, 1.1, 1.0, 0.9, 0.8, 0.7, 0.6, 0.5, 0.4, 0.3, 0.2, or 0.1 MPa) and a temperature of from about −10° C. to about 10° C.

Method 300 can further comprise discharging hydrogen 5 from the hydrogen storage device 10 by increasing the temperature in the chamber to a temperature of greater than about 273.15K (0° C.).

In aspects, a hydrogen discharging time for full discharge of hydrogen from the hydrogen storage device 10 and/or hydrogen storage system I is less (and/or a hydrogen discharging rate is greater) than a hydrogen discharging time (and/or hydrogen discharging rate) for full discharge of hydrogen from other state-of-the-art materials in a pressure range of from about 1 to about 12 bar (from about 0.1 to about 1.2 MPa). In aspects, a hydrogen discharging rate for discharging hydrogen 5 from the hydrogen storage device 10 and/or hydrogen storage system I is greater than a hydrogen discharging rate for discharging of hydrogen 5 from other state-of-the-art materials in a pressure range of from about 1 to about 12 bar (from about 0.1 to about 1.2 MPa).

In aspects, introducing hydrogen gas 5 into the sealed chamber 50 at 303, whereby hydrogen hydrates are formed within the hydrogen storage device 10, comprises introducing hydrogen gas 5 until a storage capacity (also referred to as a “full storage capacity) is reached. In aspects, the storage capacity is greater than or equal to about 1.5 wt % at pressures from about 2 to about 12 bar (about 0.2 to about 1.2 MPa), and/or is at least 2, 3, 4, and/or 5 times a hydrogen storage capacity of other state-of-the-art materials in a pressure range of from about 1 to about 12 bar (from about 0.1 to about 1.2 MPa). In aspects, the storage capacity is at least 2.5 weight percent (wt. %). For example, in aspects, such as when hydrogen storage device 10 comprises Z3-Zwi, the storage capacity is equal to about 2.5 wt % hydrogen at 6 bar (0.6 MPa).

In aspects, the hydrogen storage device 10 provides for a hydrate formation rate during method 300 that is greater than or equal 2.78 (H₂ wt %/hr), and/or at least 20 times higher than a hydrate formation rate of bulk water hydration. In some specific aspects, such as when hydrogen storage device 10 comprises Z3-Zwi, the hydrate formation rate of the hydrogen storage device 10 at 6 bar (0.6 MPa) can be more than 20 times higher than a hydrate formation rate of bulk water hydration.

In aspects, a charging time to (e.g., full) storage capacity of the hydrogen storage device 10 during method 300 is less than a charging time to (e.g., full) hydrogen storage capacity of other state-of-the-art materials in a pressure range of from about 1 to about 12 bar (from about 0.1 to about 1.2 MPa).

In aspects, the hydrogen storage device 10 is disposed over the water 40 surface and wicks water inside the pores for high interaction of water 40 molecules and hydrogen 5 molecules. Compared to slow diffusion of hydrogen gas in bulk water for bulk hydrate formation, the herein disclosed structure provided by hydrogen storage device 10 confines the hydrate formation process to the water-hydrogen interface. The pore dimension in the host framework of hydrogen storage device 10 can be about 3 nm. For 3 nm pore dimension, the water 40 molecules can form ordered ice-liked structure in the pores causing confinement of hydrogen 5 gas molecules in the regions of low water density and leading to 2-3 fold enhancement of hydrogen solubility in the water structure.

The herein disclosed hydrogen storage device 10 and hydrogen storage system I can provide for high storage capacity (e.g., 2.5 wt % at 6 bar), thus surpassing the capacity of heretofore known materials by several fold. The hydrogen storage device 10 and hydrogen storage system I of this disclosure provide for fast charging/discharging and ambient temperature discharging. The hydrogen storage device 10 and hydrogen storage system I enable storage of hydrogen gas 5 in the form of hydrogen hydrates in rationally-tuned and optionally surface-modified (e.g., mesoporous carbon) structure with long-term stability. The disclosed hydrogen storage device 10 and hydrogen storage system I overcome the hurdles of high operating pressure and slow kinetics required by conventional systems, and enable an order of magnitude reduction in the operating pressure and twenty times faster kinetics. The thin material platform of the hydrogen storage device 10 and hydrogen storage system I of this disclosure provides a compact and green platform for hydrogen storage for both stationary plants along with land and sea transportation.

The hydrogen storage device comprising a H₂-HICAP may function as a compact and green platform for hydrogen storage for both stationary plants along with land and sea transportation. In an aspect, the high capacity hydrogen storage materials and device comprising same enable the storage of hydrogen gas in the form of hydrogen hydrates in a rationally-tuned and/or surface-modified support structure is characterized by long-term stability.

Despite the tremendous potential of hydrogen hydrates as a storage medium, decades old hurdles of high operating pressure and slow kinetics have heretofore stalled their growth. The presently disclosed the high capacity hydrogen storage materials and device comprising same address these challenges by an order of magnitude reduction in the operating pressure and twenty times faster reaction kinetics. The herein disclosure hydrogen storage device enables the storage of H₂ in the form of hydrogen hydrate with long-term stability. Hydrogen hydrate functions based on trapping H₂ molecules in the lattices structure of host molecules, i.e. water. In comparison with other methods, hydrogen storage through hydrates can have advantages including ambient condition discharging process, low-cost, safety, no generated pollutant/toxic substance and no negative environmental impact. Through a rationally designed morphological and functional material platform, the storage capacity of hydrates has been increased herein by an order of magnitude and the hydrogen hydrate formation rate increased by more than 20 times. The hydrogen storage capacity of the developed material is 2-5 times of state-of-the-art materials at low pressures (e.g., pressures of 5-12 bar (0.5-1.2 MPa)).

### EXAMPLES

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can suggest themselves to one of ordinary skill in the art without departing from the spirit of the present invention or the scope of the appended claims.

The host material is schematically shown in FIG. 1a which is a nanoporous zeolite designated Z3-Zwi. This material was found to wick water inside the pores for high interaction of water molecules and hydrogen molecules. Compared to slow diffusion of hydrogen gas in bulk water for bulk hydrate formation, this structure confined the hydrate formation process to the water-hydrogen interface. The pore dimension in this host framework was chosen to be 3 nm. As shown in FIG. 1b, for 3 nm pore dimension, the water molecules form ordered ice-liked structure in the pores causing confinement of gas molecules in the regions of low water density and leading to a 2-3 fold enhancement of hydrogen solubility in the water structure. Even though gas solubility enhancement was observed in porous material with few nm pores, the solubility in 1 nm pores is almost similar to the bulk liquid as high curvature of surface did not allow strong density fluctuation of the liquid. The high concave curvature of pores wall lead to a drastic drop in the Gibbs energy barrier (ΔG*=ΔGₕₒₘ ƒ(m,x)) for hydrate nucleation through shape function f(m,x), FIG. 1c, and consequently enhanced hydrate nucleation rate. To further reduce Gibb's free energy barrier for hydrate formation, the pore surfaces were functionalized with self-assembled zwitterionic groups with thickness in the range of 0.6 nm.

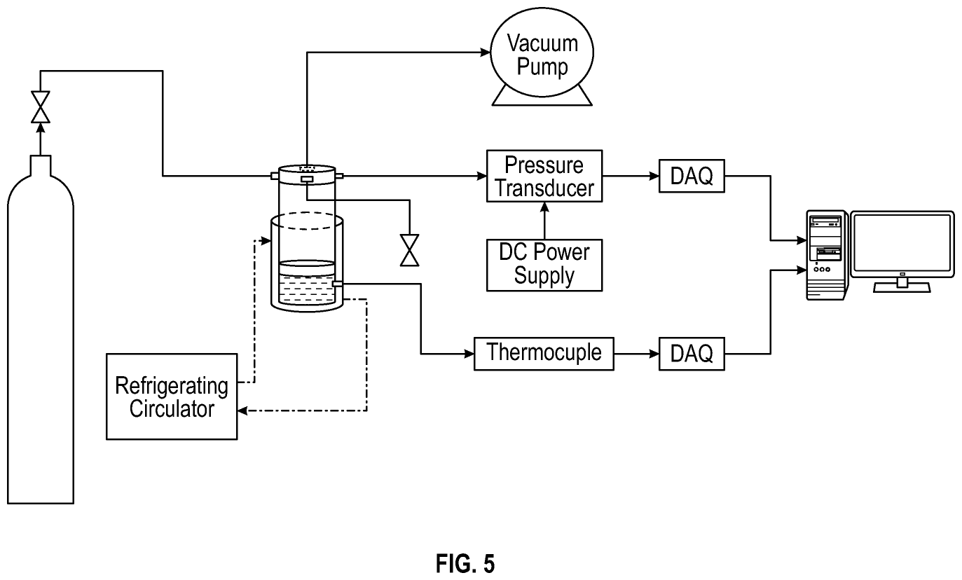

The developed material framework for hydrogen storage was used through hydrogen hydrates. The schematic of experimental platform is shown in FIG. 5. The closed system includes water, 0.1% THF promoter, the material framework and H₂ gas. In the system, the material framework floats on top of the water surface and the chamber was filled with hydrogen gas to initiate the hydrogen storage process. The hydrate formation occurred in two distinct steps: Hydrogen diffusion in water and hydrate nucleation and growth process. These two steps are separated by an induction period. This period is characterized by the time to attain stable hydrate nuclei that can grow continuously into bulk hydrate crystals. As hydrogen gas diffuses in the water or hydrate phase nucleates, the pressure in the chamber drops. To resemble a quasi-isobaric condition (e.g. charging stations), the pressure in the chamber was increased in certain intervals to keep average pressure of the system constant.

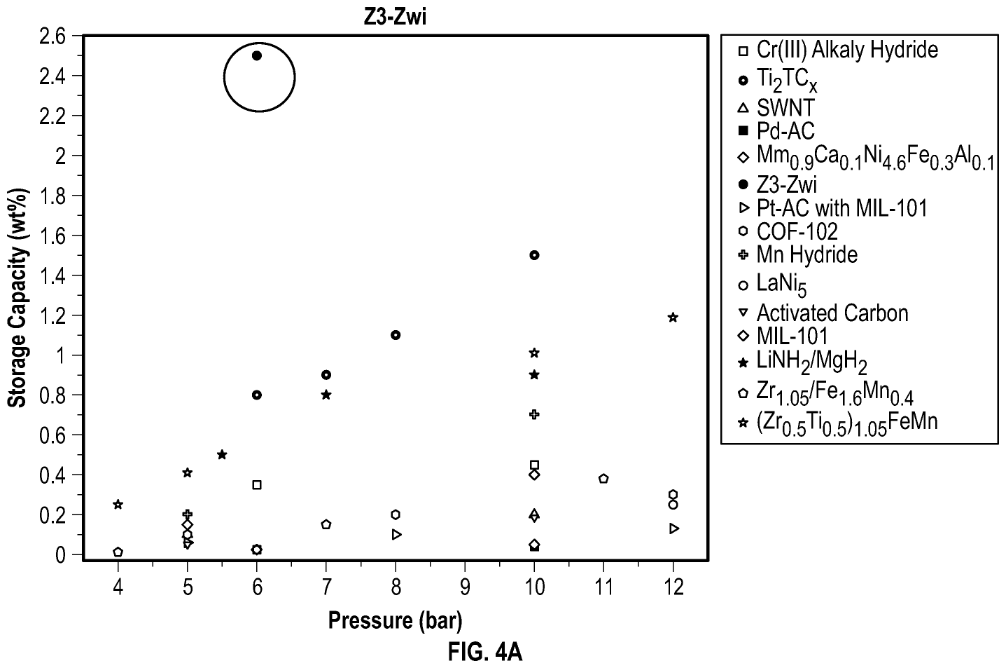

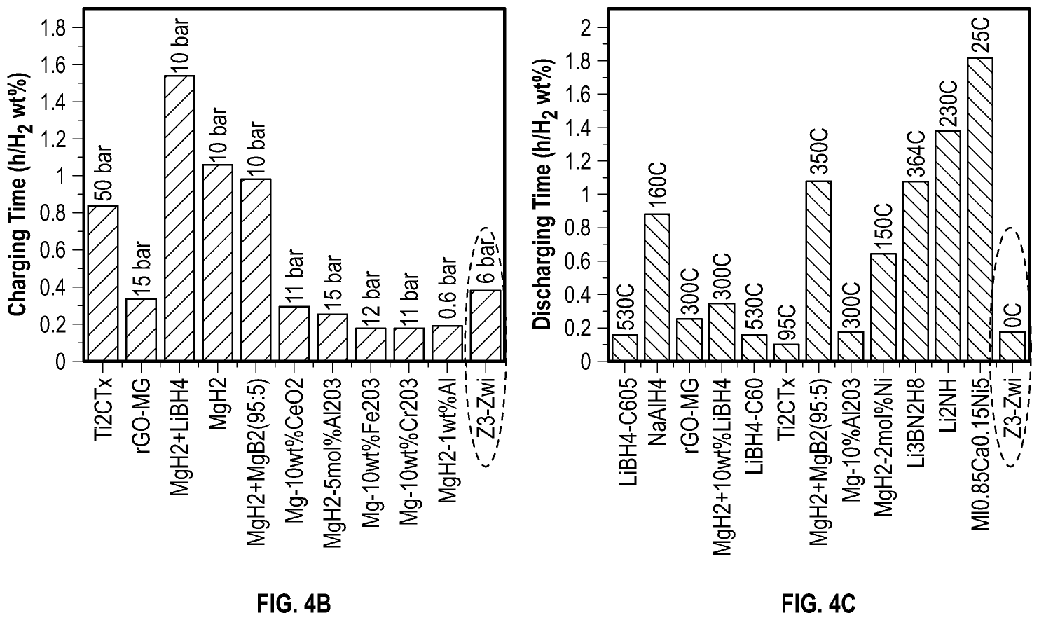

After the induction time, hydrate phase nucleates at the pores' wall-water interface as it is characterized by hydrogen pressure drop and heat release by enthalpy of liquid-solid phase change discussed later. The hydrate formation rate determined by pressure drop in the system The hydrate formation process is characterized by exothermic nature of phase change process. The temperature of the system was probed as a function of time. Through integration of temperature-time curve, it was determined that heat was released in the system through hydrate formation. This information along with enthalpy of phase change allowed for the determination of the amount of hydrogen hydrate formed in the system. Having the amount of hydrogen stored through pressure drop curves and mass of the formed hydrogen hydrate, the hydrogen storage capacity was determined. Z3-Zwi showed a storage capacity of 2.5% at pressure of 6 bar which is significantly higher than bulk water and other material platforms, FIG. 4a. This high storage capacity was caused by confinement of hydrate formation process inside the 3 nm pores. The hydrogen storage capacity of Z3-Zwi was compared with other state-of-the-art materials in the operating pressure range of 1-12 bar, FIG. 4a. This pressure range is chosen based on system feasibility for onboard light-duty vehicle and portable power applications. The Z3-Zwi offers 2-5 times higher storage capacity compared to the state-of-the-art material structures and promises a disruptive platform for hydrogen storage technologies. In addition to high storage capacity, Z3-Zwi has other advantages on charging/discharging rate compared to the state-of-the-art materials as discussed below.

Hydrogen charging rate plays an important role in the implementation of hydrogen storage technologies. The charging time of various material structures are shown in FIG. 4b. The charging pressure for each material is depicted on each graph. Despite having a low charging pressure, Z3-Zwi offers low charging time compared to the other structures. For most of the material structures, the discharging of hydrogen is achieved through high temperature or a vacuum condition. This puts a limitation on the deployment of these structures in various settings. The discharging time of various hydrogen storage materials along with their corresponding discharging temperature is provided in FIG. 4c. As shown, for some of these materials, temperatures in order of 530 K is required for the discharging process. The Z3-Zwi material platform offers one of the lowest discharging time with ambient temperature discharging temperature promising for flexibility in its implementation.

### Example 2

A hydrogen storage device of the type disclosed herein was further investigated. The closed system was defined as H₂O/THF/H₂ mixture platform. Initially, we conducted a control test with H₂O/THF/H₂O mixture to assess hydrogen storage capacity of bulk water system. The schematic of experimental setup is shown in FIG. 5. The experiments were conducted within a cylindrical stainless steel chamber with inner diameter of 2.5 cm with internal volume of 90 ml. The chamber had four ports at the top and one port at the bottom as shown in FIG. 5. The four top ports were used for H₂ injection safety valve, vacuum pump, pressure transducer, and the bottom port was used for the thermocouple. Polyscience cooling systems was used to maintain the experimental chamber at the specific temperature. Temperature was measured by a K type Omega thermocouple with 0.1 K uncertainty and pressure was recorded by ASHCROFT pressure transducer with 0.1% uncertainty. National Instruments' data acquisition system was used to record the temperature and pressure data of the chamber with 10 s interval. The required concentration of water/THF solution (0.1 mol % THF) was prepared by adding known quantity of THF in DI water. In order to maintain homogeneity of the prepared solution, it was mixed using magnetic stirrer for approximately 5 min. 30 ml of prepared THE solution was injected into the chamber and then chamber was connected to the circulating cooling jacket. For the case of hydrate formation with a material platform, the porous solid was placed on top surface of the aqueous solution, so the material is completely wetted with the solution. In order to make sure about the elimination of any air bubble in the chamber, it was pressurized with H₂ gas to approximately 0.5 MPa and depressurized to atmospheric pressure three times. After that vacuum pump was turned on to achieve almost vacuum condition inside the chamber. Then, the cooling temperature was set at 273K and when the temperature was constant, H₂ introduced into the chamber and pressurized up to 6 bar. In order to perform the quasi isobaric experiments, the pressure was set to 6 bar at the start of the experiment. As the pressure dropped to 5 bar as a result of gas consumption during the experiment, by injection of additional H₂ gas the chamber pressure was raised to 6 bar again. During the H₂ diffusion and the induction time, the system remains isothermal. However, as the hydrogen hydrate formation process is exothermic, temperature of the system rises while the pressure of the system drops due to H₂ consumption. Pressure and temperature of the system were continuously recorded until no further changes were observed and the pressure/temperature stabilized. After completion of H₂ formation from the fresh solution, dissociation of hydrogen hydrate was done by increasing the temperature of the system to room temperature, 293K and the release rate of the stored H₂ was measured through recording the pressure changes inside the chamber during dissociation. The H₂ release process was completed when no further pressure change was observed inside the chamber. The same memory solution was used again for successive cyclic experiments to assess the long-term stability.

### Hydrogen Storage Capacity

The nucleation/growth of hydrate is realized by sharp temperature jump of the system due to exothermic nature of the hydrate formation process. Here, we conducted the control experiments without Z3-Zwi in the chamber as a benchmark. Next, we conducted the experiments in a similar condition by including Z3-Zwi in the chamber. The difference in the thermal energy release was used to determine the mass of formed hydrate. The mass of consumed hydrogen divided by the mass of hydrogen hydrate is the hydrogen storage capacity of the Z3-Zwi.

### Additional Disclosure

The following are non-limiting, specific aspects in accordance with the present disclosure:

A first aspect which is a hydrogen storage device comprising (i) hydrogen gas and (ii) a host framework material.

A second aspect which is the device of the first aspect wherein the host framework comprises a porous material.

A third aspect which is the device of second aspect wherein the porous material comprises nanopores.

A fourth aspect which is the device of any the first through third aspects wherein the host framework material comprises zeolite, carbon, silica, nickel foam, carbon nanosponge (CNS), a graphene aerogel or a combination thereof.

A fifth aspect which is the device of any of the first through fourth aspects wherein the pores are substantially spherical, providing a concave shape for formation of the hydrogen hydrates.

A sixth aspect which is the device of any of the first through fifth aspects wherein host framework material comprising pores having an average diameter of from about 0.2 nm to about 10 nm.

A seventh aspect which is the device of any of the first through sixth aspects wherein a surface of the host framework material is functionalized.

An eighth aspect which is the device of the seventh aspect, wherein the surface is functionalized with zwitterions.

A ninth aspect which is the device of any of the first through eighth aspects having a stability of from about 10 cycles to about 100,000 cycles.

A tenth aspect which is the device of any of the first through ninth aspects having a storage capacity of from about 1 wt. % to about 40 wt. % at a pressure of from about 1 to about 12 bar.

An eleventh aspect which is the device of any of the first through tenth aspects having a discharge time ranging from about 1 s to about 10,000 s at a pressure of from about 1 to about 12 bar.

A twelfth aspect which is a hydrogen discharge device comprising (i) hydrogen gas and (ii) a host framework material.

A thirteenth aspect which is the device of the twelfth aspect wherein the host framework material comprises zeolite, carbon, silica, nickel foam, carbon nanosponge (CNS), a graphene aerogel or a combination thereof.

A fourteenth aspect which is the device of any of the twelfth through thirteenth aspects having a stability of from about 10 cycles to about 100,000 cycles.

A fifteenth aspect which is the device of any of the twelfth through fourteenth aspects having a storage capacity of from about 1 wt. % to about 40 wt. % at a pressure of from about 1 to about 12 bar.

A sixteenth aspect which is the device of any of the twelfth through fifteenth aspects having a discharge time ranging from about 1 s to about 10000 s at a pressure of from about 1 to about 12 bar.

A seventeenth aspect which is a method of storing hydrogen comprising introducing hydrogen gas to a host framework material comprising a zeolite, carbon, silica, nickel foam, carbon nanosponge (CNS), a graphene aerogel or a combination thereof under conditions suitable for the formation of hydrogen gas hydrates.

An eighteenth aspect which is the method of the seventeenth aspect wherein the hydrogen gas is introduced at a pressure of from about 1 to about 12 bar and a temperature of from about −10° C. to about 10° C.

A nineteenth aspect which is the method of any of the seventeenth through eighteenth aspects further comprising discharging the hydrogen gas from the host framework material.

A twentieth aspect which is a battery comprising a host framework material comprising hydrogen gas hydrates wherein the host framework material comprises a zeolite, carbon, silica, nickel foam, carbon nanosponge (CNS), a graphene aerogel or a combination thereof.

While aspects have been shown and described, modifications thereof can be made by one skilled in the art without departing from the spirit and teachings of this disclosure. The aspects described herein are exemplary only, and are not intended to be limiting. Many variations and modifications of the aspects disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both aspects with this feature and aspects without this feature are disclosed. Similarly, the present disclosure contemplates aspects where this “optional” feature is required and aspects where this feature is specifically excluded.

Accordingly, the scope of protection is not limited by the description set out above but is only limited by the claims which follow, that scope including all equivalents of the subject matter of the claims. Each and every claim is incorporated into the specification as aspects of the present disclosure. Thus, the claims are a further description and are an addition to the aspects of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

1. A hydrogen storage device, comprising:
(i) hydrogen gas; and
(ii) a host framework material, wherein the device has a discharge time ranging from about 1 s to about 10,000 s at a pressure of from about 1 to about 12 bar.

2. The device of claim 1, wherein the host framework comprises a porous material.

3. The device of claim 2, wherein the porous material comprises nanopores.

4. The device of claim 1, wherein the host framework material comprises zeolite, carbon, silica, nickel foam, carbon nanosponge (CNS), a graphene aerogel or a combination thereof.

5. (canceled)

6. The hydrogen storage device of claim 1, wherein host framework material comprising pores having an average diameter of from about 0.2 nm to about 10 nm.

7. The hydrogen storage device of claim 1, wherein a surface of the host framework material is functionalized.

8. The hydrogen storage device of claim 7, wherein the surface is functionalized with zwitterions.

9. The hydrogen storage device of claim 1, having a stability of from about 10 cycles to about 100,000 cycles.

10. The hydrogen storage device of claim 1, having a storage capacity of from about 1 wt. % to about 40 wt. % at a pressure of from about 1 to about 12 bar.

11. (canceled)

12. A hydrogen discharge device comprising (i) hydrogen gas and (ii) a host framework material, wherein the device has a discharge time ranging from about 1 s to about 10,000 s at a pressure of from about 1 to about 12 bar.

13. The device of claim 12, wherein the host framework material comprises Zeolite, carbon, silica, nickel foam, carbon nanosponge (CNS), a graphene aerogel or a combination thereof.

14. The hydrogen storage device of claim 12, having a stability of from about 10 cycles to about 100,000 cycles.

15. The hydrogen storage device of claim 12, having a storage capacity of from about 1 wt. % to about 40 wt. % at a pressure of from about 1 to about 12 bar.

16. The hydrogen storage device of claim 12, having a discharge time ranging from about 1 s to about 10,000 s at a pressure of from about 1 to about 12 bar.

17. A method of storing hydrogen, comprising:
introducing hydrogen gas to a host framework material comprising a zeolite, carbon, silica, nickel foam, carbon nanosponge (CNS), a graphene aerogel or a combination thereof under conditions suitable for the formation of hydrogen gas hydrates, wherein pores of the host framework material are substantially spherical and provide a concave shape for formation of the hydrogen hydrates.

18. The method of claim 17, wherein the hydrogen gas is introduced at a pressure of from about 1 to about 12 bar and a temperature of from about −10° C. to about 10° C.

19. The method of claim 17, further comprising discharging the hydrogen gas from the host framework material.

20. A battery, comprising:
a host framework material comprising hydrogen gas hydrates wherein the host framework material comprises a zeolite, carbon, silica, nickel foam, carbon nanosponge (CNS), a graphene aerogel or a combination thereof, wherein pores of the host framework material are substantially spherical and provide a concave shape for formation of the hydrogen hydrates.
